(19) United States
(12) Patent Application Publication
(10) Pub. No.: US 2019/0113183 A1
(43) Pub. Date: Apr. 18, 2019

(54) LUMINAIRE

(71) Applicant: FUTURE ENERGY SOLUTIONS IP & TRADEMARK, INC., FORT LAUDERDALE, FL (US)

(72) Inventors: JOSEF LEVY, AVENTURA, FL (US); JAMES ALFRED BEARS, BOYNTON BEACH, FL (US)

(21) Appl. No.: 16/161,712

(22) Filed: Oct. 16, 2018

Related U.S. Application Data
(60) Provisional application No. 62/572,912, filed on Oct. 16, 2017.

(51) Int. Cl. F21K 9/275; F21V 23/00; F21V 5/04

(52) U.S. Cl. CPC F21K 9/275; F21Y 2115/10; F21V 5/04; F21V 23/003

(57) ABSTRACT

A lighting device or luminaire is provided having a shallow body. A door in one section of the body provides access to a thermally isolated electronics chamber. The electronics components in the chamber are separated from the light source by a transverse wall.

### CROSS-REFERENCE TO RELATED APPLICATIONS

The present application claims benefit of co-pending Provisional Patent Application No. 62/572,912, filed on Oct. 16, 2017, entitled Luminaire, that application being incorporated herein, by reference, in its entirety.

### BACKGROUND OF THE INVENTION

### Field of the Invention

A luminaire is provided that has been designed from the beginning to be able to operate as a low profile, modern looking LED Fixture, while at the same time being just deep enough with all the attributes to also be effectively operated as an induction fixture.

### BRIEF DESCRIPTION OF THE DRAWINGS

For a fuller understanding of the nature of the present invention reference should be made to the following detailed description taken in connection with the accompanying drawings in which like reference numbers refer to like elements throughout the drawings and in which:

FIG. 1A is a perspective view of a solid state lighting apparatus or luminaire configured as an induction light in accordance with one particular embodiment of the invention;

FIG. 1B is a perspective view of a solid state lighting apparatus configured as an LED light in accordance with an embodiment of the invention;

FIG. 2 is a partial, transverse cross-section through a lighting apparatus in accordance with one embodiment of the invention;

FIG. 3 transverse cross-section exposing the glass and the sealing gasket;

FIG. 4 transverse cross-section showing exposing LED plate and sealing gasket;

FIG. 5 is an exploded perspective view of the top and bottom parts of the luminaire;

FIG. 6 is a side perspective view of the luminaire showing forward and backward doors;

FIG. 7 is an expanded perspective view of the center bottom region of the chassis;

FIG. 8 is an expanded view of the bottom center perspective view of the chassis;

FIGS. 9A and 9B are perspective views of the backward facing door and the forward facing door, respectively;

FIG. 10 is a perspective showing the back and front doors in a partially opened position;

FIG. 11 is a longitudinal cross-section of a luminaire provisioned for the induction lamps;

FIG. 12 is a longitudinal cross-section of a luminaire provisioned for the LED Light Sources;

FIG. 13 is a transverse cross-section through a back compartment of a luminaire in accordance with one particular embodiment of the invention;

FIG. 14 is a perspective view, taken from the bottom, of a solid state lighting apparatus or luminaire in accordance with another particular embodiment of the invention;

FIG. 15 is a perspective view of a back, bottom portion of a luminaire in accordance with one embodiment of the invention;

FIG. 15A is a perspective view of from the rear of a trap door of the back, bottom portion of FIG. 15;

FIG. 16A is a perspective view from the bottom of a luminaire top in accordance with one embodiment of the invention;

FIG. 16B is a perspective view from the top of a luminaire top in accordance with one embodiment of the invention;

FIG. 17 is a perspective view of from the bottom of a metal lens cap in accordance with one embodiment of the invention;

FIG. 18 is a partial perspective view of an assembled lens and metal lens cap in accordance with one embodiment of the invention;

FIG. 19 is a perspective view, taken from the bottom, of a luminaire in accordance with one embodiment of the invention, showing the LED lighting portion exploded;

FIG. 20 is a perspective view, taken from the bottom, of a luminaire in accordance with one embodiment of the invention, showing the LED lighting portion exploded;

FIG. 21 is a perspective view, taken from the front of an LED lighting circuit board in accordance with embodiment of the invention;

FIG. 22 is a front plan view of a lens for an LED lighting portion, in accordance with one embodiment of the present invention;

FIG. 23 is a simplified circuit diagram for a lighting circuit in accordance with one particular embodiment of the invention; and

FIG. 24 is a further simplified circuit diagram of a lighting circuit in accordance with another embodiment of the invention.

### DETAILED DESCRIPTION OF THE PREFERRED EMBODIMENT

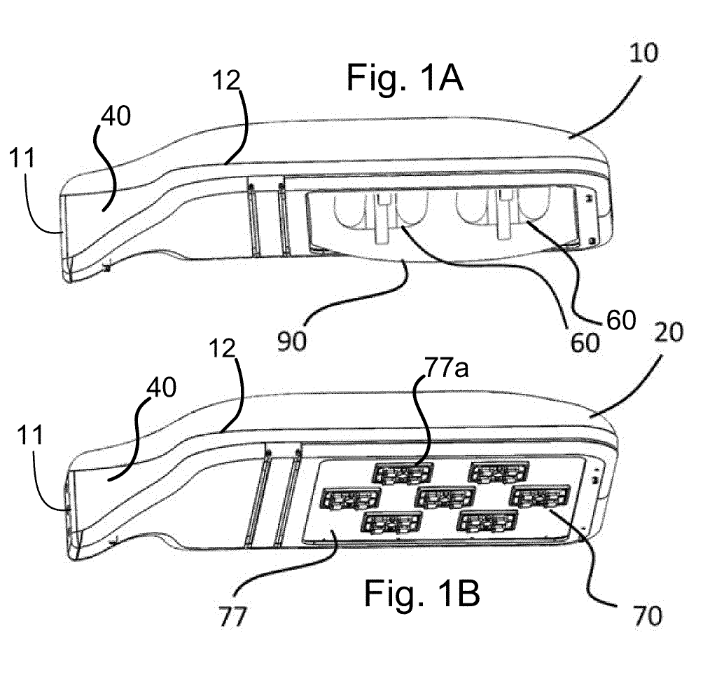

FIGS. 1A and 1B are illustrations of a luminaire in accordance with one particular embodiment of the invention. More particularly, FIG. 1A shows a lighting apparatus or luminaire 10 configured as an induction light, while FIG. 1B shows a luminaire 20, having the same chassis 40 of the luminaire 10, being configured as an LED light. In this way, the same chassis 40 of the luminaire 10, 20 can be used, interchangeably, to house an induction light or an LED light. As used herein, the term luminaire is used to mean an electric light unit that is complete with a housing, lighting source(s)/electric lamp(s) and electronic components.

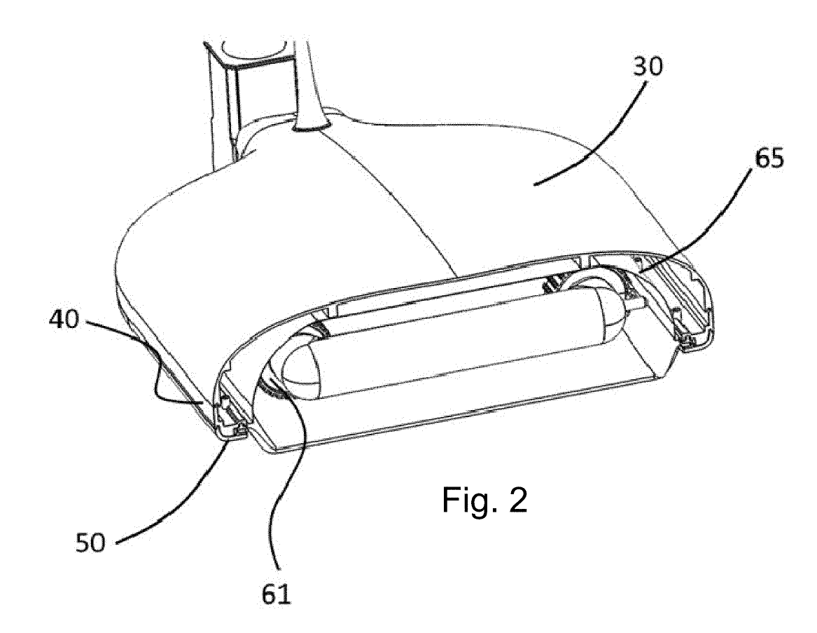

More particularly, referring now to FIGS. 1-13, there is shown a lighting apparatus having a chassis 40 configured as an induction luminaire 10 in one embodiment, and, in another embodiment, configured as a solid state lighting apparatus 20 using LEDs. The apparatus 10 includes a sealing glass cover 90 and, in the enclosed space, two induction lamps 60. The apparatus 20 includes a mounting plate 77 and LED circuit board assemblies 77a covered and sealed by lenses 70.

Induction lamps and LED lamps offer a variety of attributes that together satisfy the illumination requirements for a broad range of lighting applications. For example, induction fixtures offer a very long lamp life that can be 15 years and longer, and they provide a low glare, low luminance light having a large emitter area. It produces light similar to that of a fluorescent tube. The induction lamp can be stared at directly without causing discomfort and without undue temporary blinding. It is a good light for providing comfortable, even illumination. Induction lamps tend to top out near 90 lumens per watt in lamp efficacy. They, thus, are not nearly as electrically efficient as are LEDs, which can offer over 160 lumens per watt.

LEDs offer a small point source of light that allows lenses to distribute light very accurately. LEDs provide a means to control the light distribution on the ground more than is possible with induction lamps. The high intensity of LED emission produces high luminance and, hence, one cannot comfortably stare directly at the LEDs for any length of time. LEDs thus tend to produce more glare and a “harsher” light than induction lamps.

One of the ways to achieve the extraordinarily low profile is to let the coils 61 of the induction lamps 60 extend into and through the window area 90. One won't really see them, but this allows the metal housing to be much more shallow and modern looking.

Having the assembly parting line 12 in this position allows us to separate purely aesthetic, enclosing attributes, from structural/functional attributes. The top portion 30 can then be made very lightweight, pretty and allow many different models to be made, which is somewhat analogous to the chassis design for automobile companies. They use the same chassis to make different models that display a variety of styles.

In the induction light version of FIG. 1A, induction tubes protrude slightly, letting out more light providing wider illumination while facilitating a lower profile sleeker design.

Referring now to FIGS. 1A-3, an extremely efficient use of an optical window in the vicinity of the glass 90 enables the installed fixture to be as small & lightweight as possible. The way to achieve an extremely efficient optical window is to orient the material of the window frame 50 and chassis 40 into a largely vertical orientation rather than a horizontal orientation. The vertical orientation of the material accomplishes two objectives. Firstly, the vertical orientation moves the material upward, rather than inward, hence opening the hole and letting the light out. Secondly, the vertical orientation increases the structural moment of inertia increasing the stiffness roughly proportional to the cube of the vertical depth.

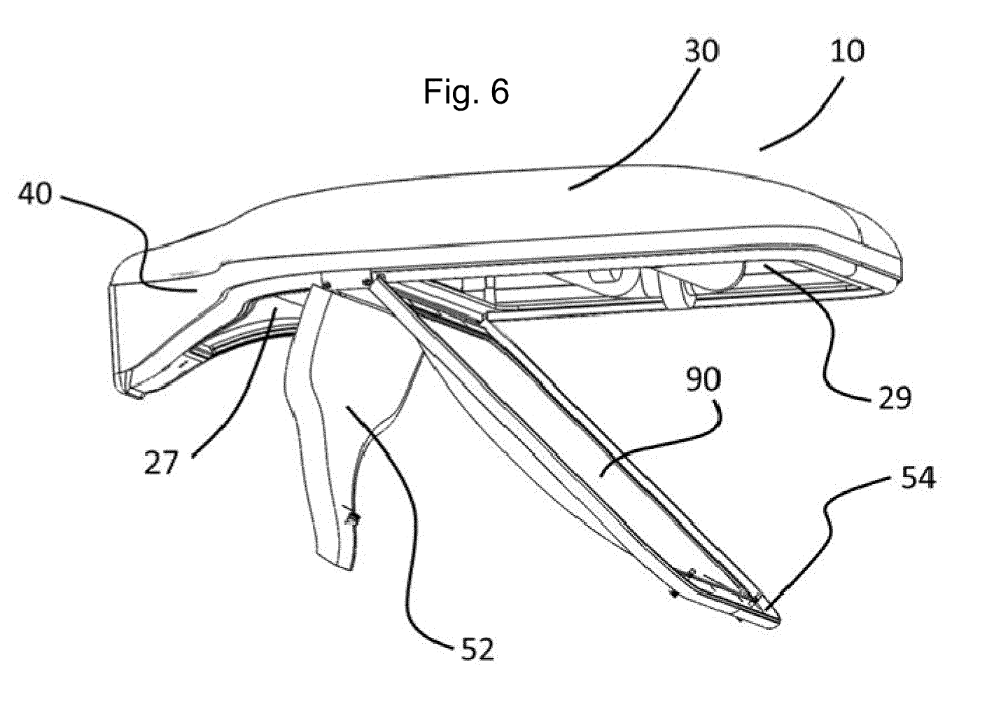

When the window is opened, the glass 90 must be lowered out of the way to provide access to the lamp chamber (29 of FIG. 6). To maintain a weather tight seal, the glass against the door 50 and the glass against the chassis 40 sits within a weather tight gasket 63 that extends around the entire periphery of the glass 90, thus protecting and cushioning the glass 90 also. Economy can be achieved by performing both sealing functions with one gasket 63. Another function of the gasket 63 is to cushion the glass so as to be able to absorb and dissipate mechanical shock energy, such as experienced during transport or handling. Being able to absorb and dissipate shock energy helps to protect the glass from cracking.

One of the ways to achieve the extraordinarily low profile of the present luminaire is to let the induction coils 61 of the lamps 60 extend slightly into the window area. This slight protrusion of the lamp coils through the window allows the metal housing 40 to be much more shallow and modern looking.

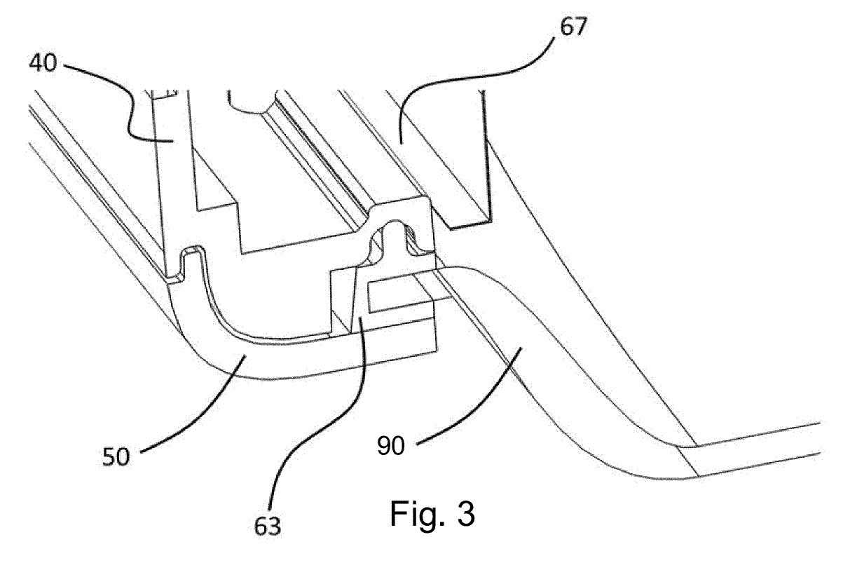

FIG. 3 is a transverse cross-section through the luminaire 10, exposing the glass 90 and the glass-sealing gasket 63 around the glass periphery that holds and cushions the glass while providing a seal.

More particularly, referring back to FIGS. 1A-3, the glass 90 is held within the glass-sealing gasket 63. The glass-sealing gasket 63 extends around the entire periphery of the glass 90.

The parting line 12 in this position allows separation of the purely aesthetic enclosure attributes from the structural/functional attributes.

The top portion 30 can then be made very lightweight, pretty and allow many different models to be made. This is somewhat analogous to the chassis design for automobile companies. They use the same chassis (frame) to make different models by adding various bodies onto the chassis and these bodies display a variety of styles.

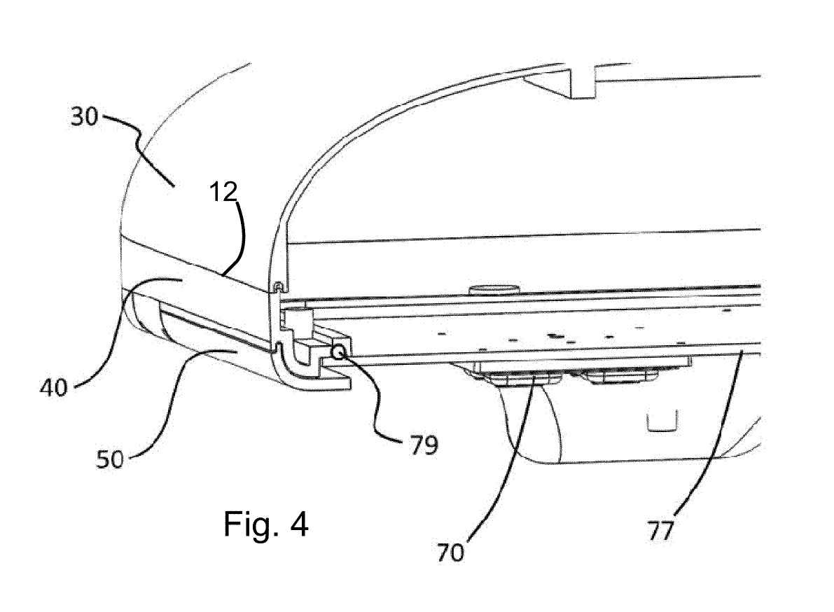

FIG. 4 is a transverse, cross-section of the LED luminaire 20 exposing the LED plate 77 and sealing gasket 79. When the gasket 79 is compressed, the LED plate 77 comes into solid contact with the bottom flat surface of the chassis 40. Tension means, such as screws, pull on the bosses 43 and the LED plate 77 thereby clamping the surfaces of the chassis 40 and LED plate 77 tightly, in order to generate a good thermal union. The good thermal union assures that there can be a large heat transfer from 77 to the chassis 40, and from there to the rest of the body and from the body to the surrounding air. The body surface area is large, due to the requirement to contain large induction lamp tubes within. This large body surface provides enough surface area to generate more than adequate heat transfer to the air provided that there is adequate heat transfer from 77 to the chassis 40.

In one particularly preferred embodiment of the invention, the middle portion of the chassis 40 is die cast separately to provide the area required to achieve a good seal with the gasket 63. The middle portion 40 also provides the surface for the clamping of the LED plate 77. The pillars 43 on the inner side of the chassis 40 provide the material for the threads of the screws or other fastener to provide a strong grip for the high tensile clamping forces to be generated that hold the LED plate 77 very tightly against the chassis 40, thereby enhancing the heat transfer from the led plate to the chassis and from there to the rest of the body of the luminaire 20. One objective of the design is to provide a sleek exterior without fins. The body, designed to accommodate the induction tubes, is already large and hence has a surface area sufficient already to dissipate enough heat without the need for additional area as could be provided by fins. Intense clamping pressures are needed to achieve a thermal “union” between the LED plate 77 and the chassis 40.

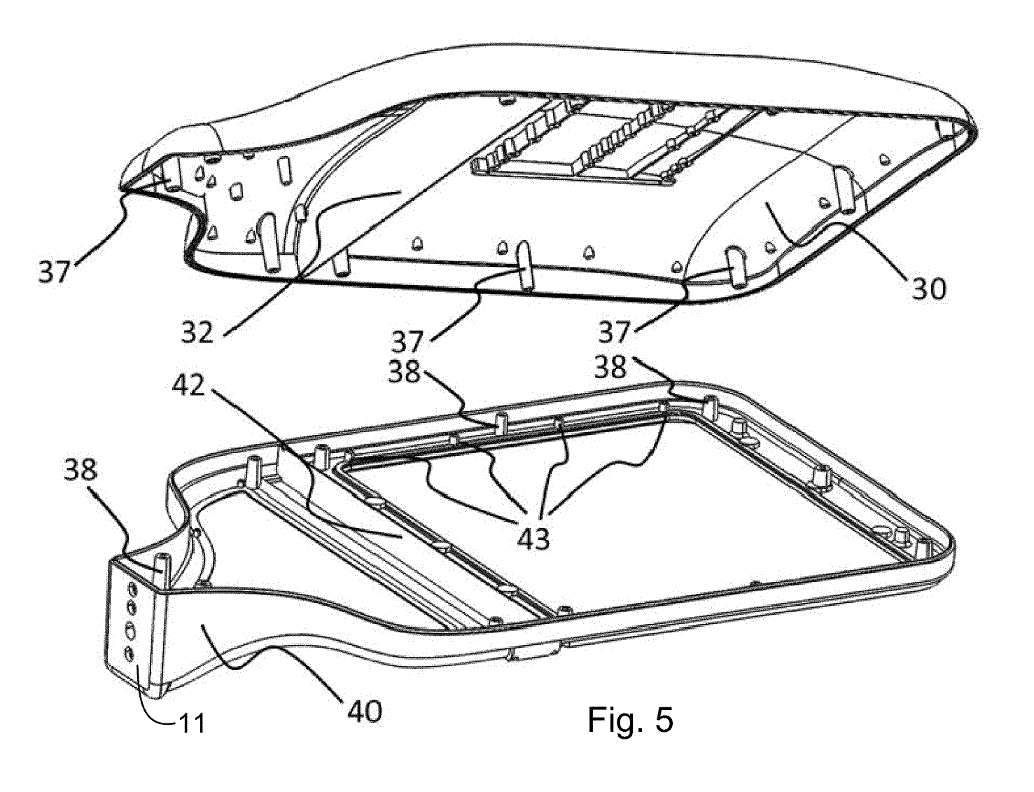

FIG. 5 is an expanded perspective view of the top 30 and bottom 40 die cast parts of the luminaires 10, 20.

Referring now to FIGS. 5-10, there is shown a top 30 containing a top-down wall portion 32 and a bottom chassis portion 40 with another bottom-up wall portion 42. When the top 30 and the chassis 40 are combined the wall joins into one piece that splits the interior space into a lamp compartment in the front and an electronics compartment in the back end.

The top portion 30 and the chassis 40 may be connected by a tension means, such as a screw, that clamps at one end, such as the head of a screw, in the in the bosses 38 in the chassis, and whose other end holds into the interior of the opposing bosses 37, through holding means such as screw threads, in the top section. If screws are used as the tension means then it makes sense to deploy thread lock in the threads to prevent the screws from ever vibrating loose. Other means for securing could include rivets. Once the top is secured to the bottom the assembly acts as one piece, having a closed curved top and an open curved bottom chassis. This shape is very functional and aesthetically pleasing and is also generally exceedingly difficult if not impossible to mold via normal die casting processes as a single part. This shape could be sand cast, but sand casting is not economical for high volume production.

The luminaire 10, 20 has been shaped at the back end 11 by the requirement to mount four of these luminaires 10, 20 at the same height against a 4 inch square pole providing up to four luminaires 10, 20 per pole at a single level without the need for any extensions. The luminaire 10, 20 narrows at the back, and the back end is long enough to assure that the luminaires 10, 20 do not interfere with each other when four of these are mounted, one against each of the four faces of a square pole having faces 4 inches or larger in width.

Separating the back electronics compartment from the lamp compartment allows the temperature of the electronics compartment to be much lower than that of the lamp compartment. Many ballasts and led drivers enjoy doubling of the operating lifetime for every 10 degrees Celsius drop in operating temperature. For example, a 40 degrees C. temperature drop could translate into a 2*2*2*2=16 fold increase in the operating lifetime of the electronics.

Referring now to FIG. 6, there is shown a luminaire 10 illustrated with both the forward facing window door 54 and backward facing trap door 52 open and hanging downward. The hinges are integrated into the center region of the chassis 40 so discretely that they are normally almost invisible. The forward facing or front door 54 and backwards facing or trap door 52 curve upward at the peripheral edges which increases the structural moment of inertia which, in turn, allows them to be strong, yet light weight. The doors 52, 54 press against gaskets abutting the chassis 40 to make hermetic seals. The upward curves at the outer edges of the forward facing door 54 makes the structure present minimal interference with the emission of light from the lamps (induction or LED) of the luminaire 10, 20. If the material of the structure in the doors 52, 54, and/or chassis 40 was horizontally oriented it would project inward and reduce the size of hole, thus blocking the emission of light from the luminaire 10, 20.

The upward curves at the outer edges of doors 52, 54 thus provide rigidity with minimal material and the forward door allows the largest hole for a given size and hence weight of luminaire. The front door 54 curves up at the front, which provides transverse rigidity. This curving upward at the edges of the front door 54 is especially important, because the front door 54 is mostly hollowed out by the large rectangular light window. The large hole in the forward facing door optimizes the induction light emission, as well as the LED function and aesthetics.

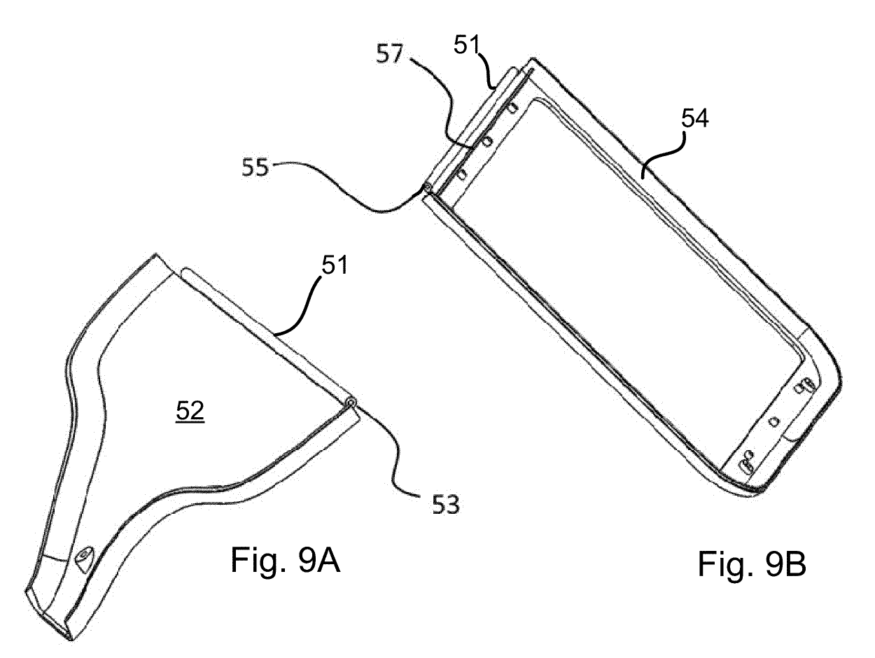

Referring now to FIGS. 9A and 9B, the back of front door 54 is flat, because it terminates on the cylindrically shaped end or hinge strut 51. The flatness at the back of the front door, if left without any compensation, would allow the sides to flex outward and would also lack transverse rigidity. Both these effects would weaken door 54. To prevent and compensate for this weakening, a transverse stiffening bar 57 is added that connects each of the lateral upward curves and the surface in between these. The bar 57 holds the upward curves at each side of door 54 in place and also provides transverse structural moment of inertia to the door 54 where it is needed in the back.

Clever use of material is required to provide sufficient strength to allow the front door 54 to clamp while providing enough pressure to seal the glass window gasket 63. If the front door 54 were not stiff enough, it would bow and, in the center of the bow, there would be little sealing pressure on the gasket 63. Our design thus allows a much smaller and lighter weight luminaire to provide the required light levels resulting in a more economical luminaire and also one that is more aesthetically interesting and pleasing in that a curved bottom can be more interesting and pleasing than the more usual flat bottoms.

The same bottom die cast “chassis” 40 as well as the same forward facing door 54 and backward facing door or trap door 52 are used for both LED luminaire 20 and the induction luminaire 10. The top portion 30 is mostly aesthetically driven, as most functional attributes are carried out by the chassis. The design of top portion 30 can, thus, be changed or not as desired.

Referring back to FIGS. 1A and 6-11, backward facing door 52 opens to expose a spacious, thermally separated, compartment for the electronics. This opening provided by the door 52 allows easy access for the electronics including ease of removing and replacing electronics parts. Also seen is the forward facing door 54, which is opened downward, exposing one or more induction lamps in the cavity 29 for ease of maintenance. The induction lamps 60 are not as sensitive to heat as is the electronics. The induction lamp 60 also creates a lot of heat so it makes sense to separate the electronics compartment thermally from the lamp compartment so that the electronics compartment may reach a much cooler equilibrium operating temperature than it would if it were exposed to the hot air from the lamp compartment.

The backward facing door 52, provides access to the electronics compartment. The forward facing door 54 provides access to the lamp compartment. Between the two compartments and hence generally in the area between the doors is the vertical member 42 that forms the bottom of the wall separating the back chamber 27 from the front chamber 29. This vertical member 42 is thus in a convenient location to provide a strengthening reinforcement to strengthen the area supporting the hinges for the doors. The member 42 also strengthens the chassis so that it can withstand the stresses not only from supporting on the luminaire in cantilever against the forces of gravity but also to be able to more than adequately resist wind loads on the luminaire under situations such as during hurricanes.

A separated compartment 27 keeps electronics cool and resilient. Another of the objectives of the design is to provide independent easy access to the front chamber 29 and the back chamber 27. The design is made very sleek by having the hinges for the doors be made as invisible as possible as well as being hermetically sealed. To achieve this, the hinges are hidden in indentations 49 in the chassis 40.

The hinge pins 47 travel through horizontal holes 41 drilled into the sides of the chassis 40. These holes do not pierce into the interior chambers 27 or 29. Instead the holes 41 for the hinge pins 47 travel from the exterior sides in to the indentations 49 in the bottom of the chassis 40 without ever piercing into either of the interior chambers.

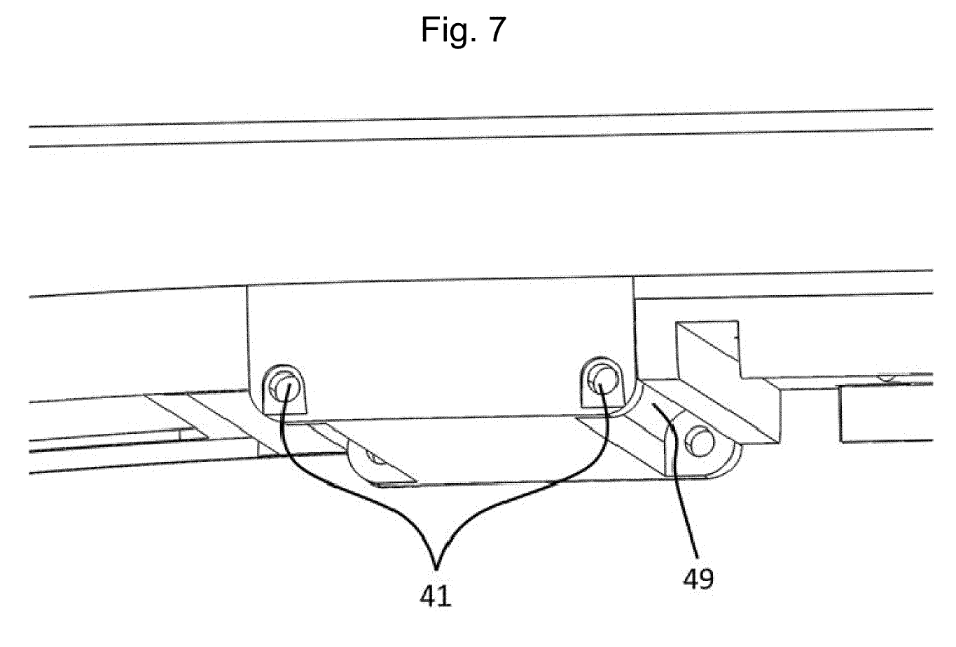

FIG. 7 is an expanded perspective view of the center bottom region of the chassis 40.

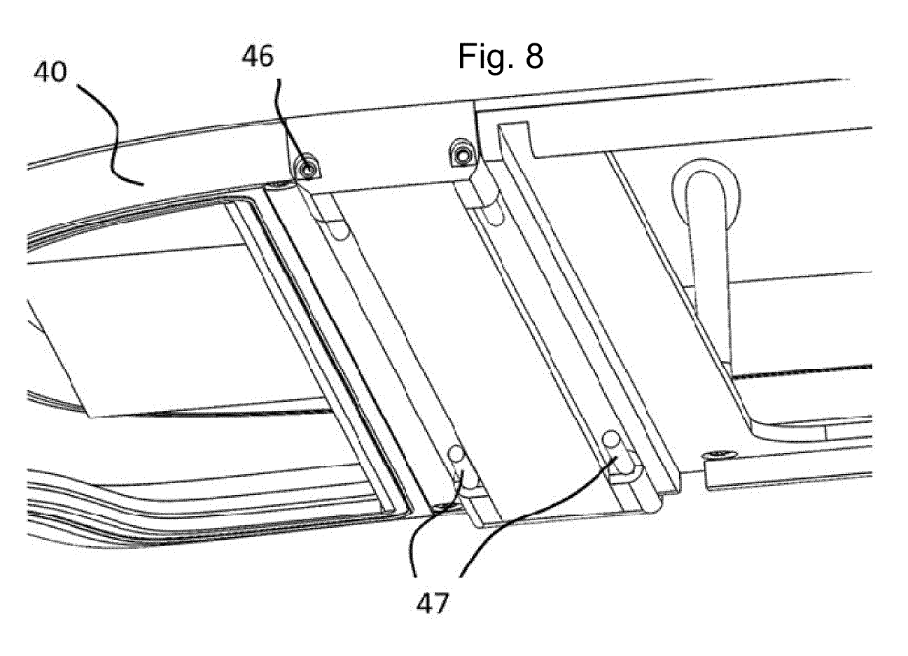

FIG. 8 is an expanded view of the bottom center perspective view of the chassis 40.

A separated compartment 27 keeps electronics cool so that it functions more efficiently and lasts a lot longer thus reducing or even eliminating the need for maintenance.

FIGS. 9A and 9B are perspective views of both the backward facing door 52 and the forward facing door 54, respectively.

As illustrated in FIG. 9A, holes 53 are provided in the backward facing door 52, in which the hinge pins 47 are to be inserted. As shown in FIG. 9B, the holes 55 are provided for hinge pins 47 to be inserted into the forward facing door 54. The hinge pins 47 fit into holes 55 and 53 of the cylindrically shaped hinge struts 51 of doors 54, 52 respectively, in a fit that allows the doors 52, 54 to rotate around the hinge, about the pins 47. A transverse stiffening bar 57 strengthens the back end of the door 54 by holding the curved sides to prevent them from bending outwards to bend longitudinally. Also the stiffening bar deepens the cross-section thus stiffening the door 54 from bending in the transverse direction.

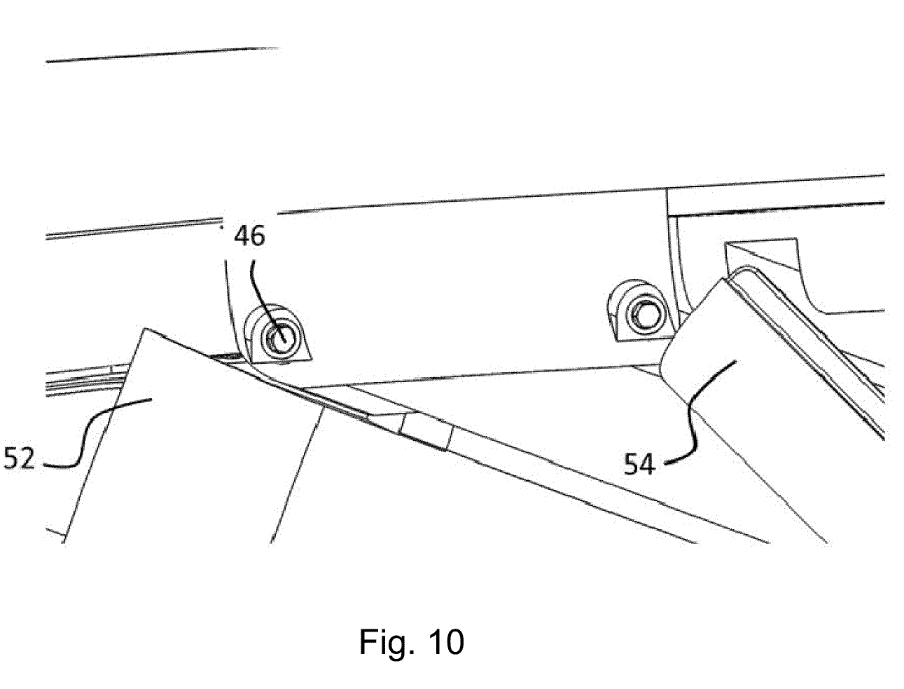

FIG. 10 is a partial, perspective view of a bottom central portion 41 of the luminaire showing the trap door 52 and front 54 doors in a partially opened position.

The hinge pins fit into holes 53 and 55 in the forward 54 and backward 52 facing doors. The hinge pins are held in place in this implementation by set screws 46 on each side. If desired, the hinge pins 47 can have integral threads at either end to hold them in place or use some other means to hold them in place.

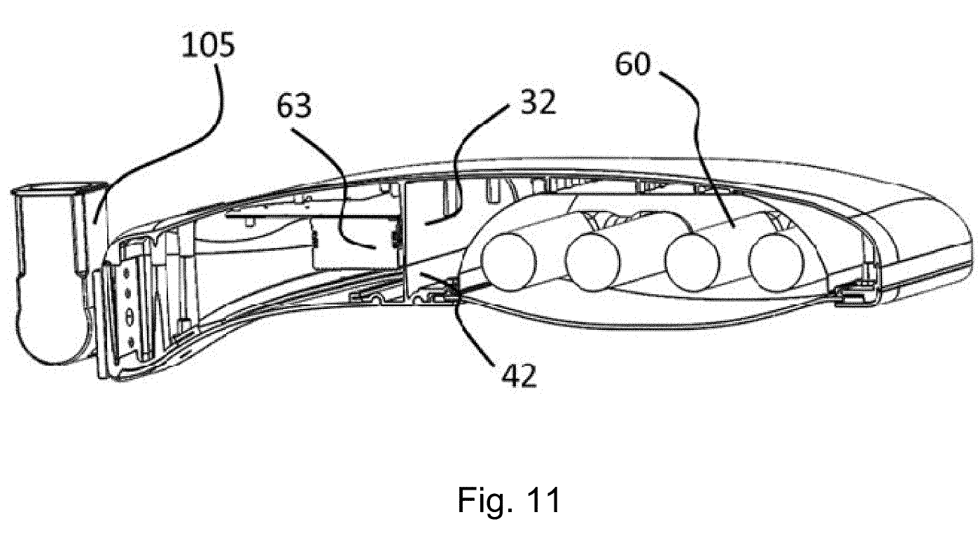

FIG. 11 is a perspective view of the longitudinal cross-section through the assembled luminaire 10 provisioned for the induction lamps 60.

In the referenced drawings we see the induction ballast in place in the electronics compartment 27. In the front we see the induction lamps 60 and reflector 65 secured in the front lamp compartment. The bracket 105 shown in drawings is an existing product called “slip fitter” and is used to attach the luminaire to a light post arm mast, which is often just a 2 inch schedule 40 pipe.

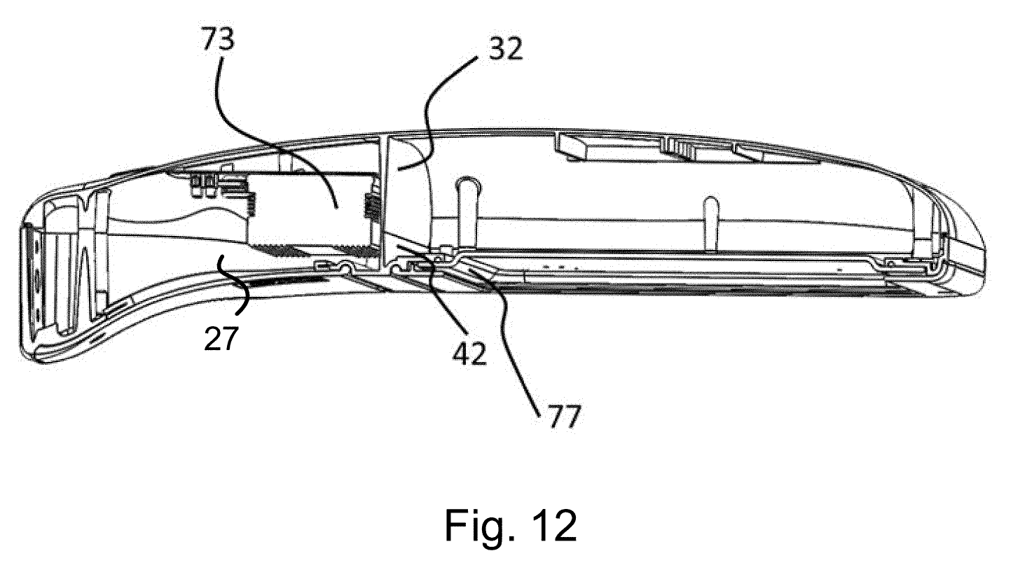

FIG. 12 is a perspective view of the longitudinal cross-section through the assembled luminaire 10 provisioned for the LED light sources.

LED driver 73 is in place in the electronics compartment 27. In the front, LED plate 77 is ready to accept the LED modules (77a of FIG. 1B) and their covering lenses 70.

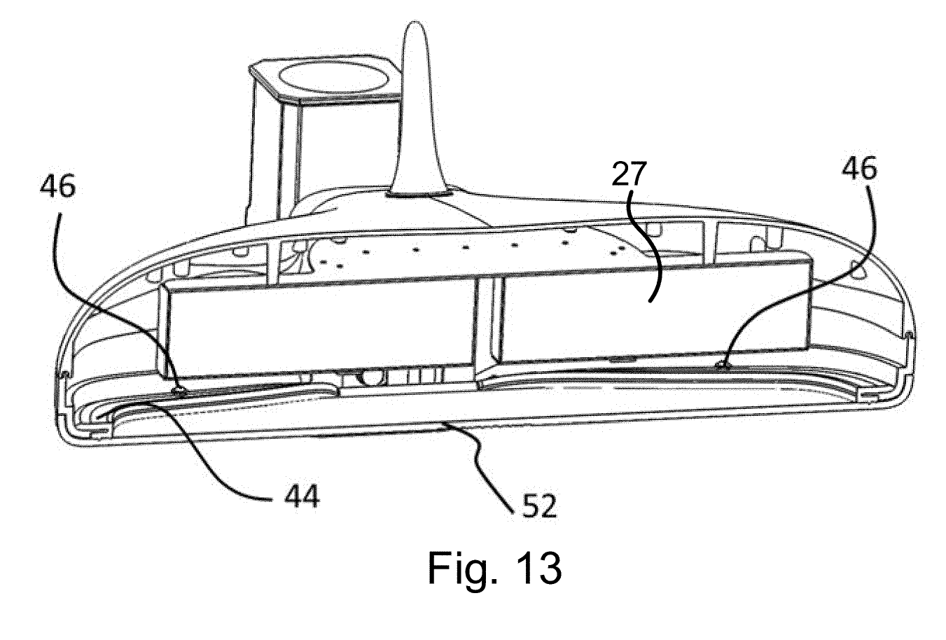

FIG. 13 is a perspective view of the transverse cross-section through the back compartment. In the referenced drawings we see the electronics driver or ballast in place in the electronics compartment 27. Exposed is the back door 52 in transverse cross-section and the trap door gasket 44. The gasket extends over and under the metallic lip that runs around the back opening in the chassis which forms the opening to the back chamber. The gasket is screwed in place by screwing into small bosses 46 in the chassis that protrude through matching holes in the gasket.

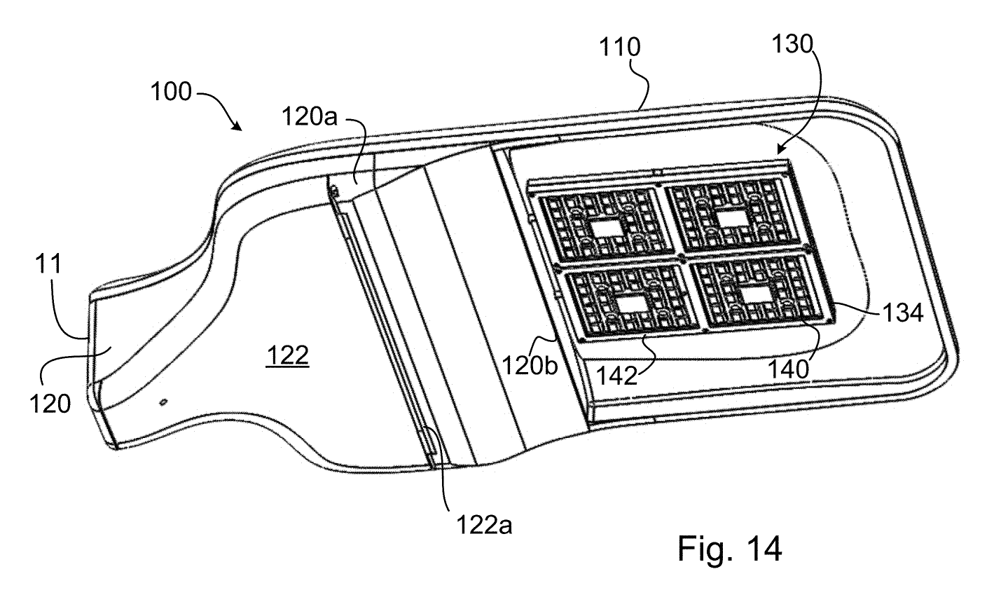

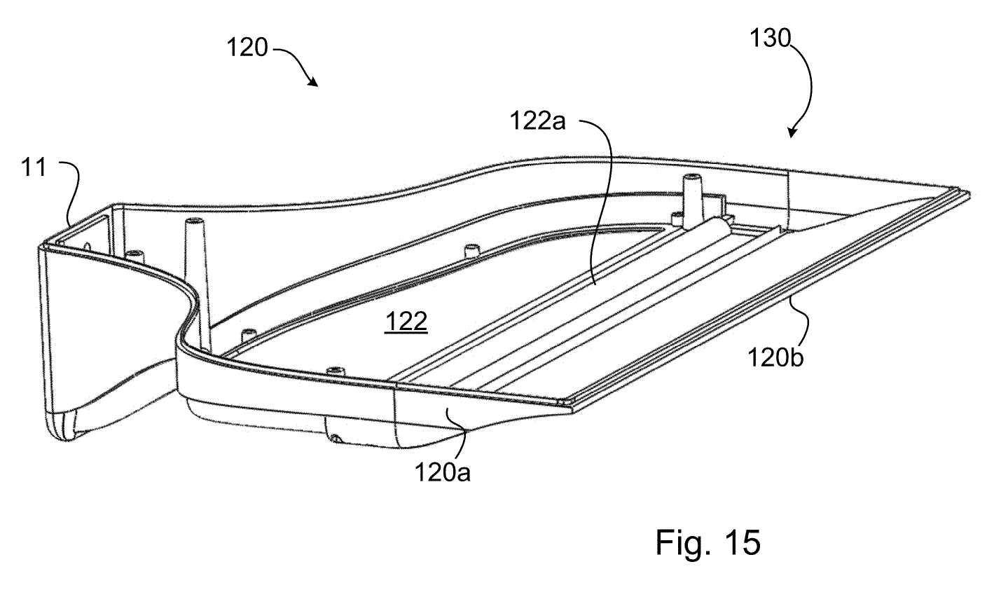

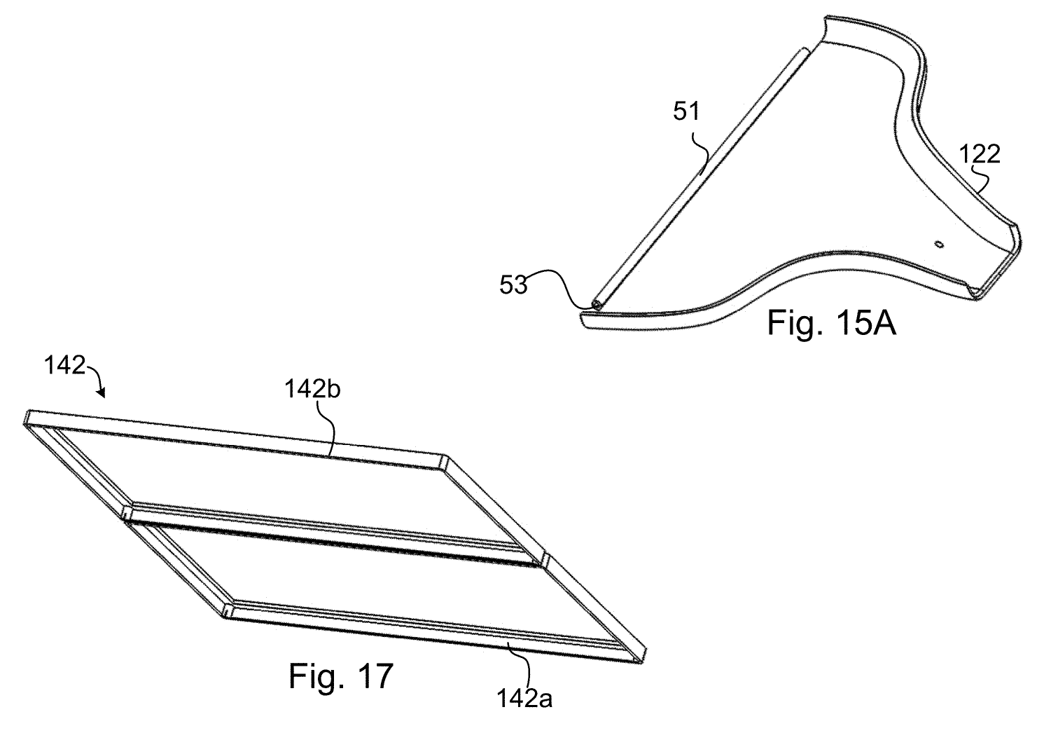

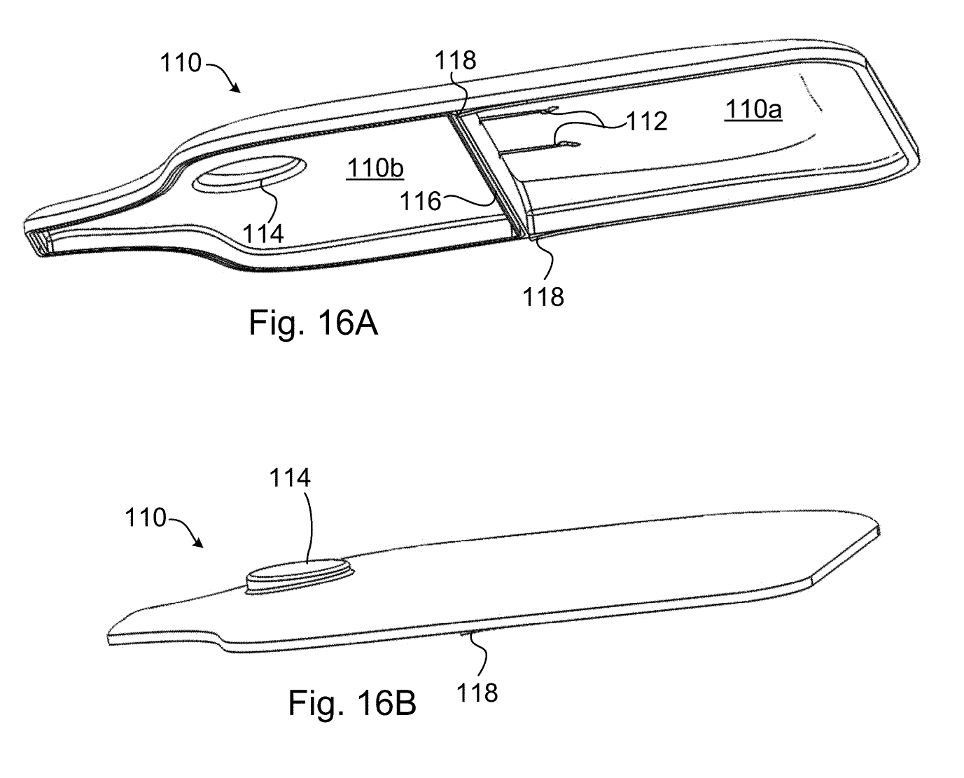

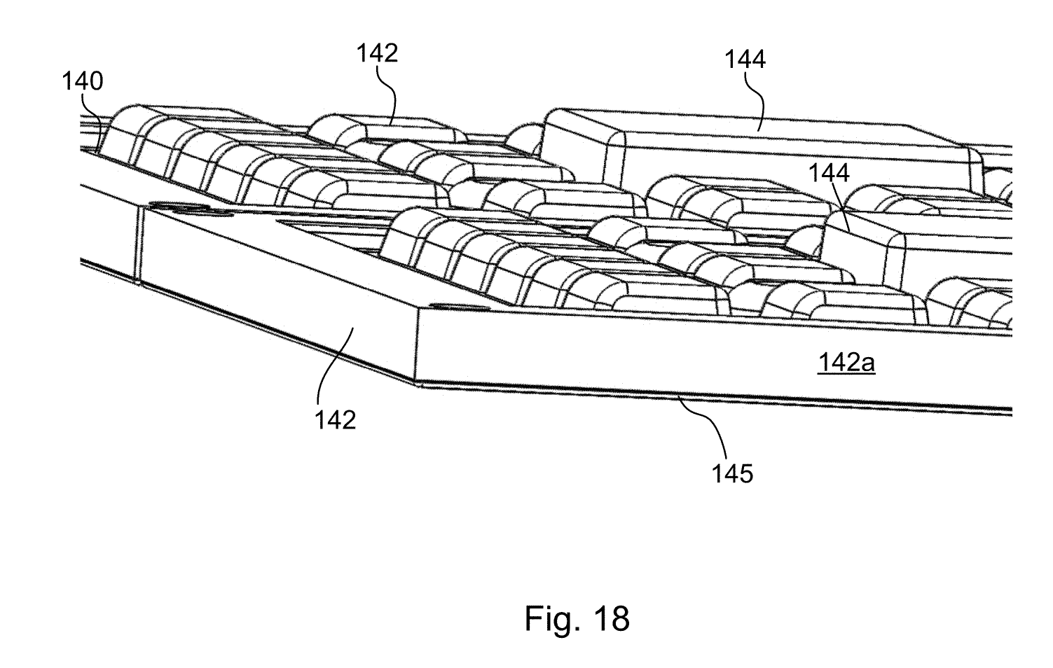

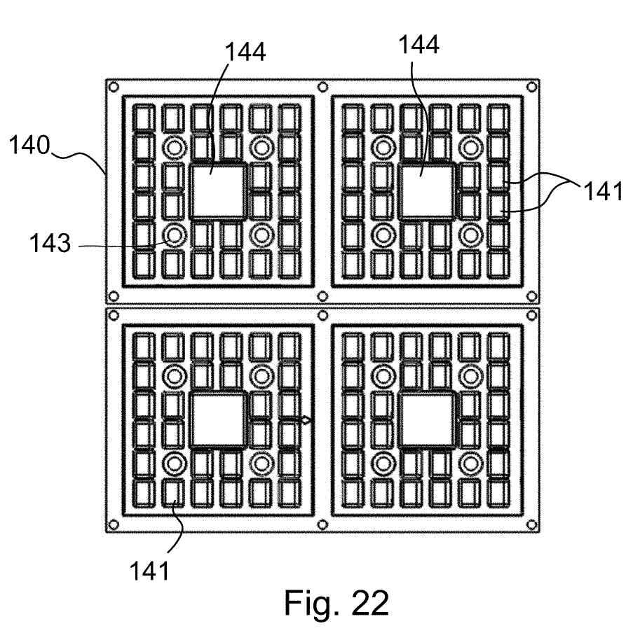

Referring now to FIGS. 14-22, there is shown another embodiment of a lighting apparatus or luminare 100 in accordance with another embodiment of the invention. Luminare 100 is similar to the luminaire 20 described above, in that it is a solid state lighting apparatus and uses LEDs. More particularly, the luminaire 100 includes a top 110, a back bottom portion 120, and an LED lighting portion 130.

Top 110 of the luminaire 100 includes an access opening 114 and wire tunnels 112, for permitting wiring to pass from electronics in the cavity formed by the top 110 and bottom 120, to the LED circuit boards 132 of LED lighting portion 130, i.e., through the separating wall 116. The LED lighting portion 130 is mounted to the front underside 110a of top 110, while the back bottom portion 120 is mounted to the rear underside 110b of top 110. The rear portion of the top 110 can be grooved or ribbed to mate with a corresponding rib or groove on the top surface of the back bottom portion 120. A sealing gasket can be used between the top 110 and the mating region of back bottom portion 120, if desired. Additionally, cleats 118 create an abutment surface that helps to keep the lip 120b of the back bottom portion 120 in place.

The back bottom portion 120 differs from the bottom portion 40 of the luminaire 20, in that no front facing door 54 of FIG. 6 is required. As such, the back bottom portion 120 has a tapered portion 120a, which tapers for a distance from the trap door hinge 122a, to its front end, thus sloping to a lip 120a. When assembled with the top 110, the lip 120a is held flush against a separating wall 116 formed on the underside of the top portion 110 of the luminaire 100. When the top 110 and the back bottom chassis 120 are combined the wall 116 separates an interior space or electronics compartment in the back end of the luminaire body from an LED light compartment in the front. Thus, the back bottom portion 120 ends before the LED lighting portion 130 begins. The back bottom portion 120 includes a rear facing door or trap door 122, which is hingedly connected to the back bottom portion 120, in the same manner as described above in connection with luminaires 10, 20, and which permits the door 122 to rotate between an open position and a closed position to provide access to the interior space of the luminaire 100. A trap door gasket (not shown) may be provided, as described above in connection with the embodiments of FIGS. 1-13. The trap door 122 provides access to electronics stored in the body of the luminaire 100, i.e., in a compartment formed between the rear underside 110b of the top 110 and the inner surface of the back bottom 120, which are protected from the environment by the closed body configuration. Wires from these electronics pass through the barrier wall 116, using wire tunnels 112, to the LED lighting portion 130, which is mounted entirely in the front underside portion 110a of the top 110 (i.e., outside the luminaire body cavity accessible by the trap door 122).

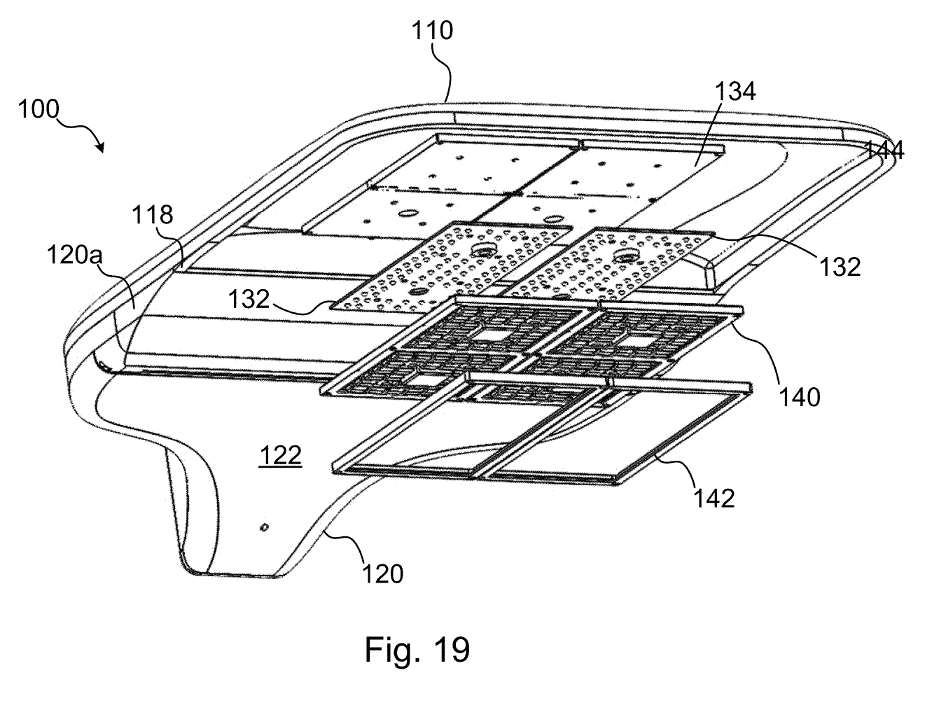

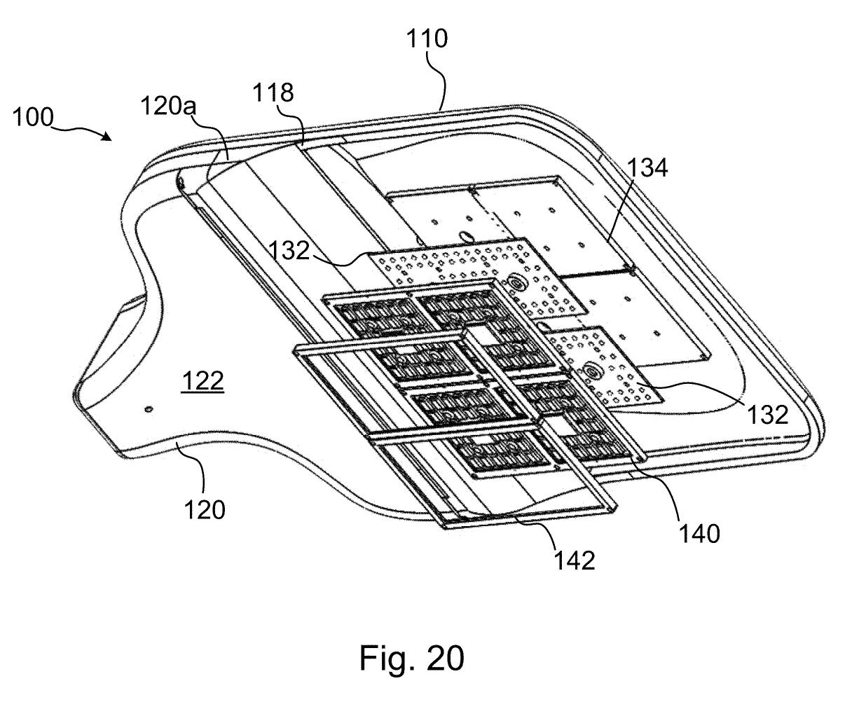

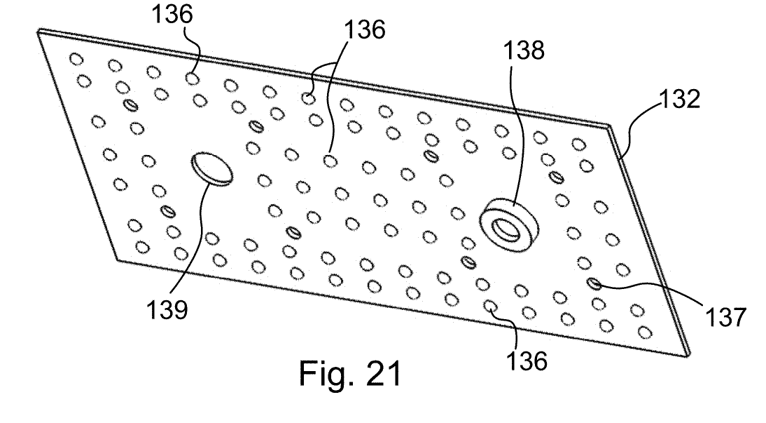

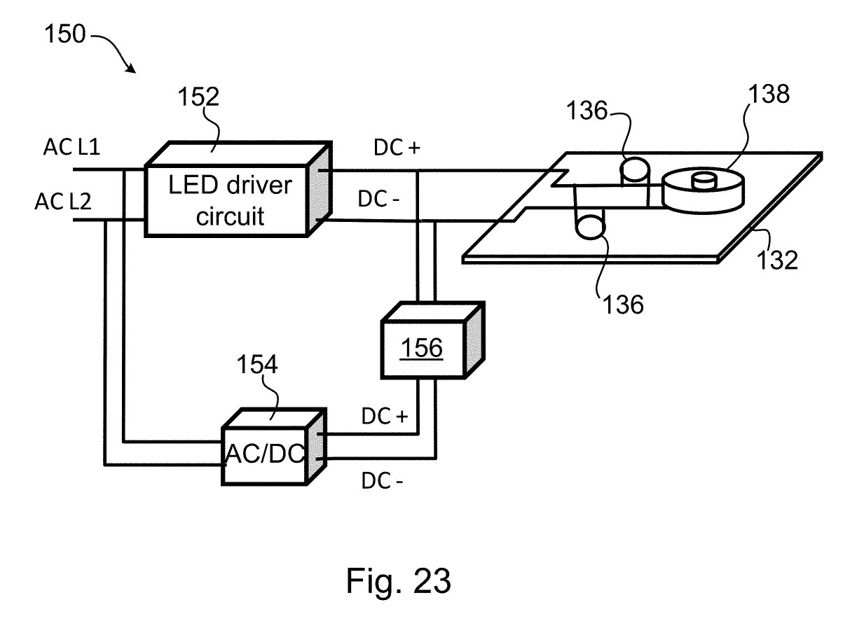

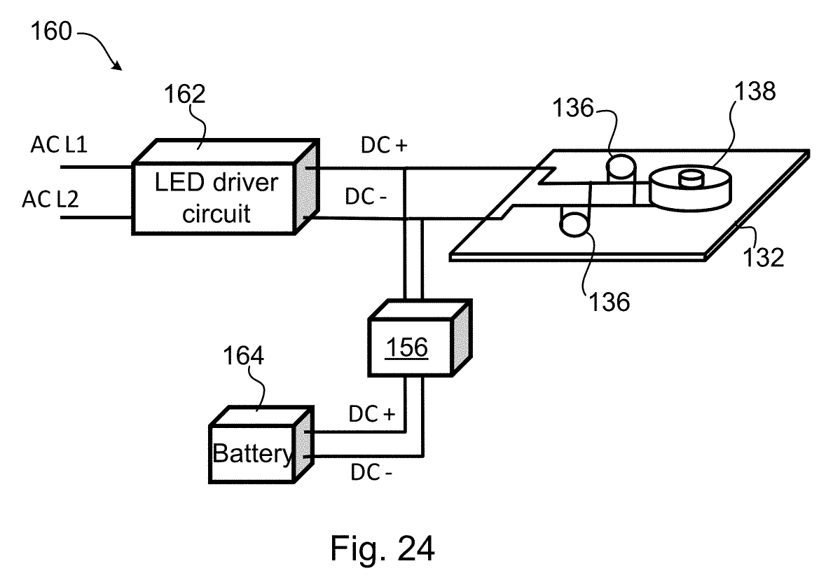

In the present embodiment, the LED lighting portion 130 includes four elements or modules, as shown more particularly in FIGS. 19 and 20. A die cast metal platform 134 is disposed between the LED circuit boards 132 and the top 110, for assisting in the distribution of heat away from the LED circuit boards 132. Circuit boards 132 include the LEDs 136 mounted thereon. In one particular embodiment of the invention, multiple LED dies 136 are mounted on each circuit board 132, and multiple circuit boards 132 are provided. For example, in the exemplary embodiment illustrated in FIG. 21, eighty-six LEDs are provided on each LED circuit board 132. Additionally LED driver circuits (152, 162 of FIGS. 23 and 24, respectively) are connected to each circuit board 132 for driving the LEDs 136. A wire hole 139 through the board 132 is provided to permit power lines to be passed to the reverse of the board 132. Other through holes 137 are provided in board 132 to permit the board to be mounted to the top 110.

In accordance with a preferred embodiment of the present invention, at least one of the LED circuit boards 132 includes one or more hidden surveillance sensors 138, such as a video camera, a motion detector and/or an acoustic detector. In many instances the users of video surveillance equipment do not wish to draw attention to the presence of video cameras. Including surveillance equipment in a luminaire, such as luminaire 100, will allow surveillance information to be obtained more readily, since people do not detect the presence of cameras and or other sensors and, hence, do not hide their faces or hide what they are doing.

LED luminaires, such as luminaires 20, 100 described above, have certain requirements. The LEDs must be supplied with DC power, they require the use of lenses and protection from the elements in the environments in which they are placed. These are the same requirements as are needed for video surveillance cameras, motion detectors and/or acoustic sensors. Acoustic sensors can be used, for example, to detect and locate gun fire. As such, in one particular embodiment of the invention, the DC power, the lens and the environmental protection are shared by the LEDs and one or more video surveillance cameras, motion detectors and/or acoustic sensors.

In one particularly preferred embodiment, the sensor 138 is an image sensor or video camera, which can be a CCD or other solid-state camera. Alternately or in addition, optical camera elements may be provided. In the event that solid-state camera components are used, image processing circuitry is additionally provided. In a further embodiment of the invention, each LED circuit board 132 includes a sensor 138.

The LED lighting portion 130 additionally includes a lens 140 that overlays the circuit boards 132. Lens 140 is faceted (having a plurality of individual facets 141, in the present embodiment, overlaying the LEDs 136) so as to direct and/or diffuse light from the LEDs 136. Additionally, in one preferred embodiment in which sensor 138 is a camera, lens 140 includes optical lens portions that do not obscure or distort images received by the sensor 138. In one particular embodiment of the invention, the portions 144 of the lens 140 in front of the video camera(s) 138 is configured to magnify the scene below for capture by the video camera(s)/surveillance sensor(s) 138. In a further particular embodiment of the invention, lens 140 is a single piece, molded lens that overlays all of the LED circuit boards 132. Bubbles 143 are formed in the lens 140, which cover the heads of screw in holes 137 of the circuit boards 132, when assembled.

Lens 140 is secured in place by a frame or lens cap 142, which has two sections 142a and 142b. In one preferred embodiment, the frame 142 is made from metal. A perimeter sealing gasket 145 on the bottom of the frame 142 may additionally be provided. If desired, as described more particularly above in connection with the luminaires 10, 20, a gasket may be provided between the back bottom portion 120 and the top 110, as well as between the frame 142 and/or lens 140 and/or the top 110.

In the present particular embodiment, each section 142a, 142b overlays the lens 140 over at least one of the two LED circuit boards 132. Frame 142 can be secured to the diecast metal platform 134. Alternately, if desired, the metal frame 142 can be secured to the underside 110a of the top 110 of the luminaire 100 or to another portion of the luminaire 100.

Referring now to FIG. 23, there is shown one particular embodiment of a circuit 150 that can be used to control the LEDs 136 of LED circuit board 132, and the surveillance circuitry, including surveillance sensor 138. As discussed above, surveillance sensor 138 can embody one or more types of surveillance sensor including, but not limited only to, a wireless video camera, a motion detector and/or an acoustic sensor. In the circuit 150, an LED driver circuit 152 is connected to the AC input lines L1 and L2. The output of the LED driver 152 is connected directly to the DC positive and negative DC+ and DC− traces on the LED circuit board 132. The LEDs 136 and the surveillance sensor 138 (i.e., camera, motion detector and or acoustic sensor) are powered in parallel. The surveillance sensor 138 draws very little power when compared to the LEDs.

The circuit 150 additionally includes an AC to DC power supply 154 in parallel to the LED driver 152, which also connects to both the LEDs 136 and the surveillance sensor 138, but operates at a lower output DC voltage than does the LED driver. During the day, or at other times when the LED driver 152 is off, the AC to DC power supply 154 provides power to the surveillance sensor 138, but at a voltage too low to supply the LEDs 136 any appreciable power, hence nearly all the energy supplied by the AC to DC power supply 154 in parallel is utilized only by the surveillance sensor 138.

The circuit 150 of FIG. 23 has two options for communicating information obtained by the surveillance sensor 138. The surveillance sensor 138 can use its on-board wireless communication capabilities to directly communicate with other independent wireless equipment, such as an IPhone using protocols, such as ZIGBEE™ or BLUETOOTH™, or it can communicate with a wireless transceiver, data storage and retrieval component 156 located in the LED driver compartment. The wireless transceiver, data storage and retrieval component 156 includes a processor configured to intercept and record data, including video data, if appropriate, transmitted by the surveillance sensor 138. Having the wireless transceiver, data storage and retrieval component 156 located in the LED driver compartment allows for better control over the range of the wireless transmissions, and also provides the opportunity to collect and store an extended period of video data. This allows the surveillance sensors 138 to remain small, so as to fit into the lens and to be very inconspicuous. Referring now to FIGS. 14 and 23, in one preferred embodiment of the invention, all of the electronics illustrated in circuit 150, except for the LED circuit board 132, are located in a compartment of the luminaire 100 created by the union of the top 110 and back bottom portion 120, and accessible by the trap door 122.

Referring now to FIG. 24, there is shown another embodiment of a circuit 160 for controlling the LEDs 136 of the circuit board 132 and the surveillance circuitry, including surveillance sensor 138. More particularly, as with the embodiment of FIG. 23, the output of the LED driver 162 is connected directly to the DC positive and negative DC+ and DC− traces on the LED circuit board 132, such that the LEDs 136 and the surveillance sensor 138 (i.e., camera, motion detector and or acoustic sensor) are powered in parallel. Again, the surveillance sensor 138 draw very little power when compared to the LEDs 136. In the embodiment of FIG. 24, however, the circuit 160 does not have a second AC to DC power supply. Instead, a battery 164 is provided that is charged from the output of the LED driver 162. The battery 164 is connected in parallel with the output to the LED Driver 162, and thus is able to power the surveillance sensor 138 at a voltage low enough that the LEDs do not turn on to any appreciable extent. The battery 164 has enough charge capacity to power the surveillance sensor 138 long enough to keep it energized until the LED Driver 162 comes back on and again recharges the battery 164. As with the embodiment of FIG. 23, a wireless transceiver, data storage and retrieval component 156 is provided as part of the circuit 160. Similar to the embodiment of FIG. 23, in one preferred embodiment of the invention, all of the electronics illustrated in circuit 150, except for the LED circuit board 132, are located in a compartment of the luminaire 100 of FIG. 14 created by the union of the top 110 and back bottom portion 120, and accessible by the trap door 122.

It should be noted that, if desired, the embodiments of FIGS. 1-13 can additionally be modified to include one or more surveillance sensors and their associated circuitry, as discussed above in connection with FIGS. 14-24.

Accordingly, while a preferred embodiment of the present invention is shown and described herein, it will be understood that the invention may be embodied otherwise than as herein specifically illustrated or described, and that within the embodiments certain changes in the detail and construction, as well as the arrangement of the parts, may be made without departing from the principles of the present invention as defined by the appended claims.

The invention claimed is:

1. A luminaire, comprising:
a top portion;
a bottom portion;
at least one light source;
said top portion and bottom portion configured to fit together to form an interior cavity;
at least one of said top portion and said bottom portion having an inside transverse wall forming a separation of the interior cavity into a front compartment and a back compartment; the front compartment having an opening in the bottom and the back compartment having an opening in the bottom;
a trap door rotationally connected to said bottom portion by a trap door hinge, said trap door configured to rotate on said trap door hinge between an open position and a closed position covering said back compartment opening;
a front door rotationally connected to said bottom portion by a front door hinge, said front door configured to rotate on said front door hinge between an open position and a closed position covering said front compartment opening; and
said bottom portion additionally including an intermediate portion separating a connection point for said trap door hinge from a connection point for said front door hinge so that the trap door and the front door do not overlap.

2. The luminaire of claim 1 configured to, interchangeably, receive solid state lighting sources or one or more induction lamps as its at least one light source.

3. The luminaire of claim 1, wherein said top portion and said bottom portion are die cast, and are held together by tension means pulling on opposing bosses in the top and bottom.

4. The luminaire of claim 1, wherein said at least one light source is located in said front compartment and accessible through said front door and said back compartment is configured as a thermally isolated electronics chamber accessible through said trap door.

5. The luminaire of claim 1, wherein said front door and said trap door open in opposite directions from one another.

6. The luminaire of claim 1, wherein each of said front door and said trap door curves upwards at each of its lateral sides.

7. The luminaire of claim 1 in which the hinge side end of the trap door and the front door each have cylindrically shaped hinge portions that fit into an indentation in the bottom, each door hinge including hinge dowels resting in holes through the sides of the bottom, said hinge dowels extending into holes formed in said cylindrically shaped hinge portions.

8. The lighting device of claim 7, further comprising set screws screwed into threads in said holes through the sides of the bottom to hold said hinge dowels in said bottom.

9. A luminaire, comprising:
a top portion;
a bottom portion;
said top portion and bottom portion configured to fit together and form a rear interior cavity and a front lighting compartment, said rear interior cavity and said front lighting compartment separated by a transverse wall of at least one of said top portion or said bottom portion;
said interior cavity and said front lighting compartment each having a bottom opening;
a trap door rotationally connected to said bottom portion by a trap door hinge, said trap door configured to rotate about said trap door hinge between an open position and a closed position covering the bottom opening of said rear interior cavity; and
at least one light source disposed in said front lighting compartment.

10. The luminaire of claim 9, further comprising a front door rotationally connected to said bottom portion by a front door hinge, said front door configured to rotate on said front door hinge between an open position and a closed position covering said front lighting compartment; and
said bottom portion additionally including an intermediate portion separating a connection point for said trap door hinge from a connection point for said front door hinge so that the trap door and the front door do not overlap.

11. The luminaire of claim 9, wherein bottom portion ends at said transverse wall, before said front lighting compartment, and said bottom opening of said front lighting compartment is not covered by a door.

12. The luminaire of claim 9, wherein electronics for said at least one light source are located in said rear interior cavity and said transverse wall includes wiring tunnels through said wall so wires from said electronics in said rear interior cavity can pass through said wall to said at least one light source.

13. The luminaire of claim 12 wherein said at least one light source includes at least one LED circuit board.

14. The luminaire of claim 13, wherein said electronics includes an LED driver.

15. The luminaire of claim 13, further comprising at least one surveillance sensor mounted on said at least one LED circuit board.

16. The luminaire of claim 15, wherein the at least one surveillance sensor is at least one of a video camera, a motion sensor and/or an acoustic sensor.

17. The luminaire of claim 16, wherein said electronics further include a wireless transceiver, data storage and access component for communicating information from said at least one surveillance sensor remotely.

18. The luminaire of claim 9, wherein said at least one light source is a lighting module including at least one LED light board, said at least one LED light board including a plurality of lighting LEDs and at least one surveillance sensor.

19. The luminaire of claim 18, wherein the lighting module additionally includes a lens disposed over said at least one LED light board and a lens frame.
